(19) United States
(12) Patent Application Publication
(10) Pub. No.: US 2008/0273332 A1
(43) Pub. Date: Nov. 6, 2008

(54) Light Device

(75) Inventors: Gunnar Luettgens, Aachen (DE); Josef Andreas Schug, Wuerselen (DE); Ludo Haenen, Sint Oedenrode (NL); Lingli Wang, Heeze (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/090,885

(22) PCT Filed: Oct. 18, 2006
(86) PCT No.: PCT/IB06/53831

§ 371 Date: Apr. 21, 2008

(30) Foreign Application Priority Data
Oct. 21, 2005 (EP) 05109815.0

(51) Int. Cl. F21V 29/00

(52) U.S. Cl. 362/294

(57) ABSTRACT

A light device comprising a side emitting light source (1) having a predetermined spatial intensity distribution, at least one optical element (2) and a base (3) as a heat sink, on which the light source (1) is supported, whereby the light device is formed in such a way that different optical elements (2) are mountable on the base (3) in order to achieve individual characteristics of light (6) leaving the light device.

This invention relates to a light device comprising an emitting light source, at least one optical element and a base as a heat sink, on which the light emitting device is supported.

It is known to use light devices, including light emitting sources (LEDs), e.g. Lambertian emitters in a variety of applications, including vehicular applications. LEDs are attractive due to their small size and the fact that they consume less power relative to incandescence light sources. The popularity of LEDs as light sources is expected to continue and increase as their potential benefits are further developed, particularly with respect to increased light output.

Today LED signal lamps normally apply several LEDs. This enables the designer to realize different optical concepts and stylings. The disadvantage of this described solution is that it is rather complicated and expensive. Furthermore, no standardized light devices can be used. Known light devices applying one single LED provide only limited possibilities for different optical designs and stylings.

Thus, there is a need to create an improved light device providing more advanced optical design- and styling opportunities by providing modified spatial radiation patterns.

The invention has for its object to eliminate the above mentioned disadvantages. In particular, this is an object of the invention to provide a light device with a cheap, small and simple setup, whereby the applicability for different optical concepts can be improved. This object is achieved by a light device as taught by claim 1 of the present invention. Advantage embodiments of the inventive device are defined in the subclaims.

Accordingly, a light device is provided, comprising a side emitting light source, e.g. a light emitting diode (LED), having a predetermined spatial intensity distribution, at least one optical element and a base as a heat sink, on which the light source is supported, whereby the light device is formed in such a way that different optical elements are mountable on the base in order to achieve individual characteristics of light leaving the light device. One of the advantages of the present invention is that a light device is achieved with spatial optical elements arranged around the LED. With these said optical elements different spatial intensity distributions can be achieved, which are adjusted to individual requirements, particularly to automotive signal lamps. One of the essential advantages of this invention is that the use of a standard light sources with different optical elements is possible allowing the use of rather cheap, mass-produced modules as light sources for different lamps. In an alternative embodiment, the optical elements may be also exchangeable. Preferably, the optical element is connected with the base by a form fit and/or adhesive bond and/or a frictional connection. According to one possible embodiment of the present invention the optical element can be fastened at the base of the light emitting source with screws or a click fastening, which allows easy mounting and the use of different exchangeable optics with the same base device. Depending on the requirements the optical elements can be placed around the light-emitting source and/or above light emitting source to modify the spatial intensity distribution. The light device comprises a suited substrate providing an electrical connection of the LED and a path of low thermal resistance, preferably smaller than 20 K/W to remove the heat dissipated in the LED. Side emitting light sources (main light intensity under large angles to the forward direction) emit light with angular distributions deviating from a Lambertian distribution (main intensity in forward direction).

According to a preferred embodiment the light device can comprise a connecting element, which connects the optical element with the base. The light device can comprise a plurality of connecting elements, which can be integrated with the optical elements. That means that the optical element and the connecting element are a one-piece element. The connecting element can be attached to the base by various attachment methods, including but not limited to snap-fitting, friction-fitting, heat-staking, adhesive bonding or ultra-sonic-welding. In this case the base can comprise openings, in which one side of the connecting element is mounted.

Preferably, the optical element is a lens made of glass or a transparent plastic. The lens can be manufactured as a separate component using a number of well-known techniques such as diamond turning (i.e., the lens is shaped by a lathe with a diamond-bit), injection molding and casting. According to different possible embodiments of the present invention the lens can be made of a transparent material, including PMMA (polymethylmethacrolate) and/or PC (polycarbonate) and/or silicones and/or fluorocarbon polymers.

Advantageously, the light is refracted by the optical element and directed to at least one light guide or reflector. Preferably, the optical element can comprise in inner surface and an outer surface, wherein a light is produced being symmetrical or asymmetrical.

In order to create individual characteristics of the light leaving the light device the optical element coupled to the base can comprise a variety of forms. In one preferred embodiment the optical element is a ring prism, whereby in this arrangement the emission of the side emitting LED is bent downwards, which allows to design flat reflectors coupled with the base. The emitted light of the side emitting light source is refracted at the inner and outer surface of the ring prism. The light leaves the ring prism being refracted at the outer surface of said prism. The intensity of the emitted light is directed downwards in order to achieve flat reflectors or to guide the leaving light into light guides.

In a preferred embodiment the optical element comprises a recess or a hole, in which at least a part of the light source is positioned. The optical element can be formed as a cap, surrounding the light source. The cap can comprise tilted surfaces refracting the light in a predetermined direction. Alternatively, the inner and/or the outer surfaces of the optical element have a structure of a Fresnel lens. Advantageously, said Fresnel lens structure reduces the amount of material required compared to a conventional optical element by breaking the lens into a set of concentric annular sections. For each of these zones, the overall thickness of the optical element is decreased, effectively chopping the continuous surface of a standard lens into a set of surfaces of the same curvature, with discontinuities between them.

In one embodiment, it is preferred that the inner surface comprises at least one convex part and/or at least one concave part in order to achieve individual characteristics of light leaving the light device. Also, the outer surface can comprise at least one convex part and/or at least one concave part. In one embodiment of the invention the optical element comprises at the inner surface and at the outer surface a plurality of small convex lenses. Each lens element receives a part of the emitted light and distributes the light into light packs. Advantageously, the light packs are guided into light guides or to a reflector to achieve for example a star-shaped illumination. Preferably, the optical element and said lenses are made of the same piece element.

For producing an asymmetrical light output the inner surface can be formed with a plurality of convex and concave lenses. The convex lenses bundle the light into light packs, wherein the concave lenses distribute the light to different possible directions. Such optical elements can be applied in the automotive industry, particularly for rotational symmetrical reflectors emitting an asymmetrical light bundle.

Alternatively, the light device can comprise an optical element with a reflective surface. In one alternative the optical element is a mirror, which reflects the light emitted by the LED. Also, the reflective surface can be a layer or a film on the optical element. The reflective film can be metallized, sputtered, or the like with highly reflective materials including, for example, aluminium (Al) and/or nickel chrome (NiCr). Other materials as a reflective surface are applicable like silver. Generally, the reflective surface is mounted above the LED. Reflective coatings might be part of the module. The radiation reflected by the reflective surface seems to come from a light source rather high above the LED, which enables to design very flat reflectors as an extra part.

Preferably, the light device can comprise filters for color correction. Such filters, particularly filters for absorption or for interference are used for mixing the color of the radiation leaving the light device. Advantageously, the filters are placed on the surface of the optical element. In accordance with another embodiment, the light device comprises a heat sink or heat fins connected to the LED die via a path or a low thermal resistance to remove the heat produced in the die. Furthermore, the light device may be connected with an internal electronic driver comprising resistors, constant current source and for example multi-level PWM driver. The light device can be covered by an outer housing with sealing devices in order to get a water proof device.

The preferred invention relates to an optical element for a light device, which comprises a side emitting light source having a predetermined spatial intensity distribution and a base as a heat sink, on which the light source is supported, wherein the optical element is placeable around the light source and/or above the light source, wherein the optical element is a ring prism or a cap and/or the optical element comprises at least one refractive surface with at least one convex part and/or at least one concave part. Advantage embodiments of the inventive optical element are defined in the subclaims. Preferably, connecting elements connect the optical element with the base. Alternatively, the optical element is fixed to another object, e.g. to a reflector. That means that the optical element is not connected with the base, directly.

The inventive devices can be used in a variety of systems amongst them systems being automotive systems, home lighting systems, backlighting systems for this place, ambient lighting systems or shop lighting systems. Especially the invention is primary meant for all kind of automotive single lamps (stop lamp, tail lamp, turn indicator, fog lamp, daytime running light, etc.) but can be used in all kind of lamps for automotive and general lighting systems like torches, office lighting, architecture lighting, home lighting or shop lighting.

The aforementioned components, as well as the claimed components and the components to be used in accordance with the invention in the described embodiments, are not subject to any special exceptions with respect to their size, shape, material selection and technical concept such that the selection criteria known in the pertinent field can be applied without limitations.

Additional details, characteristics and advantages of the object of the invention are disclosed in the subclaims and the following description of the respective figures—which in an exemplary fashion—show different preferred embodiments of the light device.

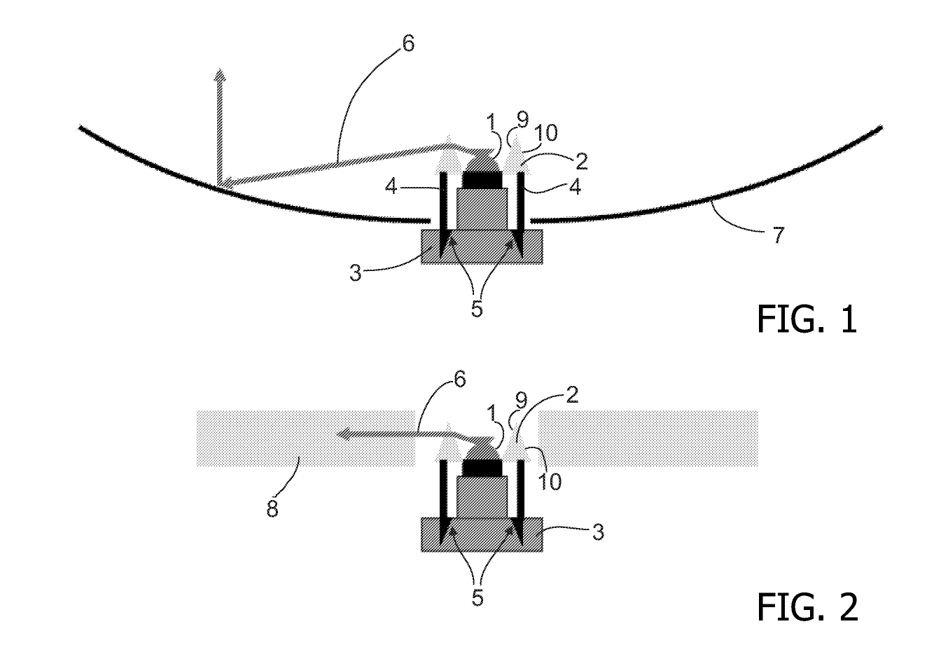

FIG. 1 shows a side view of a light device with a light emitting source, an optical element and a base, placed in a reflector, which is no part of the module

FIG. 2 shows a side view of an alternative light device with a light emitting source, a base and an optical element placed in a light guide,

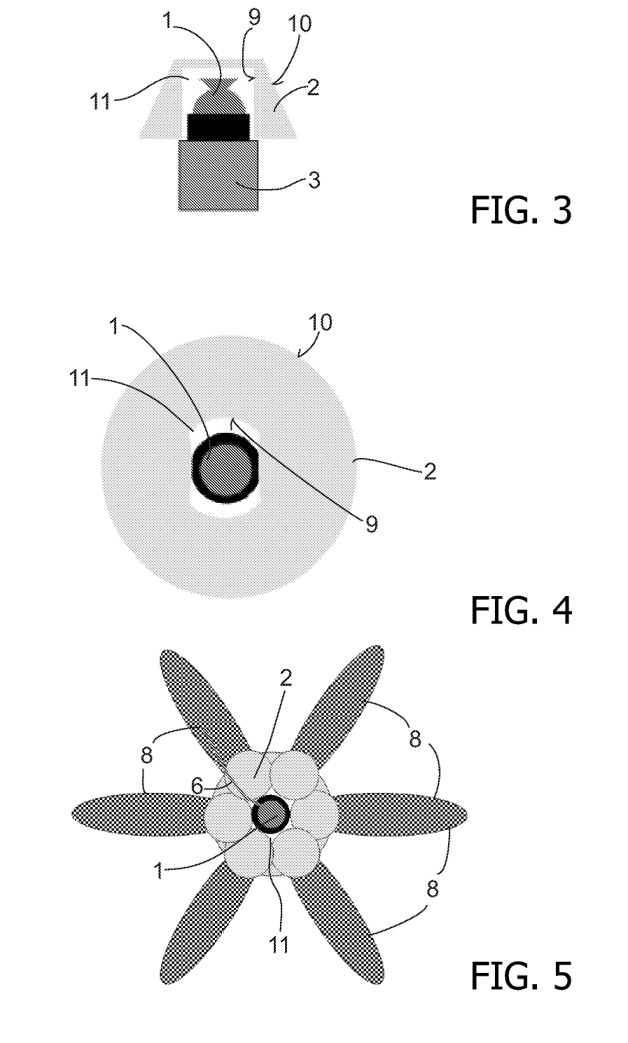

FIG. 3 illustrates a side view of an alternative light device with a cap as an optical element,

FIG. 4 shows a top view of a further embodiment of an optical element,

FIG. 5 shows a top view of a further possible embodiment of a light device, whereby the light is directed to light guides positioned in a stellar form to each other,

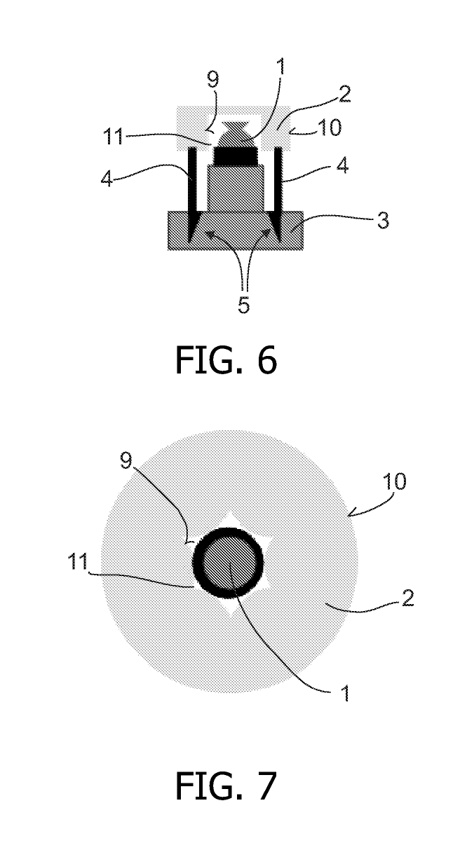

FIG. 6 shows a side view of a further alternative of a light device with a cap as an optical element and

FIG. 7 shows a top view of the light device according to FIG. 6.

FIG. 1 illustrates an example of a light device with a side emitting LED package 1, an LED module base 3 and an optical element 2, working as a prism 2. The prism 2 is coupled to the LED module base 3 by connecting elements 4. The LED 1 is a conventional side emitter with an LED chip (not shown). However, it must be clearly understood that the invention can be used with any LED configuration or packaging now known or later device. The LED 1 is connected through wires or conductive leads (not shown) to a conventional drive circuit (not shown) powered in turn by a battery (not shown) or other conventional source. The base 3 as a heat sink provides positional alignment and thermal management for the LED 1. The base 3 coupled with the LED 1 comprises cooling fins, which are not shown explicitly. The heat sink 3 is composed of a thermally conductive material, typically a metal.

The optical element 2, which consists of a transparent plastic or glass, is formed as a ring prism around the LED 1. In another not shown embodiment the ring prism 2 can be turned upside down obtaining different light output characteristics. The connecting element 4 is connected with the heat sink 3 e.g. by a click fastening. That means that at the opposite side of the optical element 2 the connecting element 4 extends into openings 5 of the base 3. One of the advantages is that the optical element 2 can be easily fixed to the LED package 1 coupled with the device base 3. In this arrangement the emission of the side emitting LED 1 is bent downwards, which allows to design flatter reflectors. As shown in FIG. 1 the light 6 leaves the LED 1 in direction to the optical element 2. The light 6 is refracted at the inner 9 and the outer surface 10 of the ring prism 2, whereby the leaving radiation 6 is bent to a reflector 7 connected with the light device. Finally, the radiation 6 is reflected by the reflector 7 to the front.

FIG. 2 illustrate the LED 1 with the base 3 and the optical element 2 according to FIG. 1, whereby the light 6 leaves the ring prism 2, horizontally. The light 6 is directed to a light guide 8, which can be made from optically transmissive materials, including but not limited to PC or PMMA. The light guide 8 may be of constant thickness or tapered. Side emission of light allows efficient illumination of thin light guides 8 with a thickness in the optimum range of 1-10 mm.

FIG. 3 illustrates the light device with a LED 1, a base 3 and an optical element 2 formed as a cap. The optical element 2 comprises a recess 11, in which the LED 1 is placed. The recess 11 is designed with an inner surface 9 having a cylindrical form. Furthermore, the optical element 2 comprises an outer surface 10 being inclined or rather tapered. In this embodiment the LED 1 is protected by the cap 2. During the illumination process the emitted light 6 of the LED 1 is refracted at the inner 9 and the outer surface 10, wherein a light output is achieved which is horizontal or bent downwards.

FIG. 4 shows an optical element 2 with a recess 11 in the centre, in which the LED 1 is positioned. The recess 11 is designed with an inner surface 9 comprising two concave and two convex parts. The outer surface 10 has a cylindrical form. The convex parts of the inner surface 9 bundle the light into light packs, wherein the concave parts distribute the light to different possible directions. Thus, an asymmetrical light output can be achieved by the illustrated optical element 2 even using a rotational symmetric reflector or lightguide.

FIG. 5 describes a further embodiment of a light device, which comprises six light guides 8. In this arrangement light 8 can be guided into certain directions. Thus, a symmetrical star-shaped illumination can be obtained. The optical element 2 has a form of a ring having an inner surface 9 of a plurality of convex surface parts, which act as a lens. Furthermore, the outer surface 10 comprises a plurality of convex surface parts. The inner surface 9 is a part of a recess 11, in which the LED 1 is positioned. During the illumination process the light 6 is refracted at the convex parts of the inner surface 9 and the outer surface 10 in such a way that the emitted light 6 is bundled into six light packs directed to said light guides 8.

FIG. 6 and FIG. 7 show a light device with a side emitting LED 1, an optical element 2 having a form as a cap and a base 3 as a heat sink, on which the LED 1 is supported. The optical element 2 is fixed to the base 3 by connecting elements 4, which extend into openings 5 of the base 3. In this embodiment the LED 1 is positioned in a recess 11 of the cap 2, which is designed with an inner surface 9 comprising six convex surface parts. The outer surface 10 has a cylindrical form.

All optical elements 2 of the illustrated embodiments are fixed to the base 3, explicitly described in FIG. 1. Certainly, it is possible that the optical element 2 can be fixed to another object being positioned near to the base. The given numbers of arms of the lightguide or facets are only examples, the invention is not restricted to these numbers, other numbers are possible as well.

### LIST OF NUMERALS

1 light emitting source
2 optical element
3 base
4 connecting element
5 openings
6 light, radiation
8 light guide
9 inner surface
10 outer surface
11 recess

1. A light device comprising
a side emitting light source (1) having a predetermined spatial intensity distribution,
at least one optical element (2) and a base (3) as a heat sink, on which the light source (1) is supported,
whereby the light device is formed in such a way that different optical elements (2) are mountable on the base (3) in order to achieve individual characteristics of light (6) leaving the light device.

2. The light device as claimed in claim 1, characterized in that the optical element (2) refracting the light (6) is placed around the light source (1) and/or above the light source (1).

3. The light device as claimed in claim 1, characterized in that a connecting element (4) connects the optical element (2) with the base (3).

4. The light device as claimed in claim 3, characterized in that the connecting element (4) is integrated with the optical element (2).

5. The light device according to claim 1, characterized in that the base (3) comprises openings (5), in which one side of the connecting element (4) is mounted.

6. The light device according to claim 1, characterized in that the optical element (2) comprises a recess (11), in which at least a part of the light source (1) is placed.

7. The light device according to claim 1, characterized in that the optical element (2) is a ring prism (2) or a cap (2).

8. The light device according to claim 1, characterized in that the light (6) is refracted by the optical element (2) and directed to at least one light guide (8).

9. The light device according to 1, characterized in that the optical element (2) comprises in inner surface (9) and an outer surface (10), wherein the light (6) leaving the light device is produced being symmetrical or asymmetrical.

10. The light device as claimed in claim 9, characterized in that the outer surface (10) of the cap (2) is tapered.

11. The light device according to claim 1, characterized in that the inner (9) and/or the outer surfaces (10) comprise a structure of a Fresnel lens.

12. The light device according to claim 1, characterized in that the inner surface (9) comprises at least one convex part and/or at least one concave part and/or the outer surface (9) comprises at least one convex part and/or at least one concave part.

13. An optical element (2) for a light device, which comprises a side emitting light source (1) having a predetermined spatial intensity distribution and a base (3) as a heat sink, on which the light source (1) is supported,
wherein the optical element (2) is placeable around the light source (1) and/or above the light source (1),
wherein the optical element (2) is a ring prism (2) or a cap (2) and/or the optical element (2) comprises at least one refractive surface with at least one convex part and/or at least one concave part.
